(19) United States
(12) Patent Application Publication
(10) Pub. No.: US 2015/0139876 A1
(43) Pub. Date: May 21, 2015

(54) AMINE-CONTAINING SCRUBBING SOLUTION WITH OZONE AND/OR HYDROGEN PEROXIDE FOR ABSORBING CARBON DIOXIDE

(71) Applicant: Siemens Aktiengesellschaft, Munich (DE)

(72) Inventors: Björn Fischer, Dusseldorf (DE); Stefan Hauke, Einhausen (DE); Ralph Joh, Seligenstadt (DE); Markus Kinzl, Dietzenbach (DE); Diego Andres Kuettel, Kassel (DE); Ansgar Kursawe, Niedernhausen (DE); Rüdiger Schneider, Eppstein (DE)

(73) Assignee: Siemens Aktiengesellschaft, Munich (DE)

(21) Appl. No.: 14/411,228

(22) PCT Filed: Jul. 3, 2013
(86) PCT No.: PCT/EP2013/063981

§ 371 Date: Dec. 24, 2014

(30) Foreign Application Priority Data
Jul. 5, 2012 (DE) 102012211707.5

(51) Int. Cl. B01D 53/62; B01D 53/56; B01D 53/14

(52) U.S. Cl. CPC B01D 53/62; B01D 53/1475; B01D 53/1493; B01D 53/56; B01D 2257/504; B01D 2252/204; B01D 2252/20478; B01D 2252/20494
USPC 423/224; 252/186.1; 252/186.21; 252/186.43

(57) ABSTRACT

A method for depositing carbon dioxide from a flue gas (RG) of a combustion system is provided. A scrubbing solution (A) with an amine-containing absorption agent is mixed together with ozone and/or hydrogen peroxide as an oxidizing agent for nitrite. The flue gas (RG) is brought into contact with the scrubbing solution (A) prepared in this manner, whereby carbon dioxide contained in the flue gas is absorbed, and the scrubbing solution (A) is then thermally treated, whereby the carbon dioxide is desorbed. A corresponding scrubbing solution (A) with an amine-containing absorption agent and with ozone and/or hydrogen peroxide as an oxidizing agent for nitrite is also provided.

### CROSS REFERENCE TO RELATED APPLICATIONS

This application is the US National Stage of International Application No. PCT/EP2013/063981 filed Jul. 3, 2013, and claims the benefit thereof. The International Application claims the benefit of German Application No. DE 102012211707.5 filed Jul. 5, 2012. All of the applications are incorporated by reference herein in their entirety.

### FIELD OF INVENTION

The invention relates to a scrubbing solution for absorbing carbon dioxide from a flue gas of a combustion system. The invention further relates to a method for depositing carbon dioxide from a flue gas of a combustion system by means of such a scrubbing solution.

### BACKGROUND OF INVENTION

During the combustion of a fossil fuel in a combustion system, such as, for example, in a fossil-fired power station for generating electrical energy, the flue gas formed is loaded with carbon dioxide to a not inconsiderable extent. In addition to carbon dioxide, such a flue gas contains further combustion products, such as, for example, the gases nitrogen, sulfur oxides, nitrogen oxides and water vapor, as well as solid particles, dusts and carbon black. The flue gas is usually released into the atmosphere after extensive deposition of the solid constituents. If appropriate, nitrogen oxides and/or sulfur oxides are also separated off catalytically or by wet chemistry methods. As a natural constituent of the earth's atmosphere, however, carbon dioxide is conventionally also released into the atmosphere.

The increase in the content of carbon dioxide in the earth's atmosphere caused by man, however, is held responsible as the main cause of the increase in the earth's surface temperatures called climate change. Carbon dioxide present in the atmosphere in fact impedes the radiation of heat from the earth's surface into space, which is generally known as the greenhouse effect.

In this respect, suitable secondary measures are being discussed for existing power station installations in order to remove the carbon dioxide formed out of the flue gas after the combustion. As a technical possibility for this the flue gas is brought into contact with a scrubbing solution to which a suitable absorption agent for carbon dioxide is added. Amine-containing absorption agents currently appear to be the most promising, amines employed being, in particular, alkanolamines, but also more complex sterically hindered amines having large alkyl groups, cyclic amines, amino acids or amino acid salts. Either the amines employed form carbamates with carbon dioxide, or the carbon dioxide reacts indirectly in the scrubbing solution to give bicarbonate and a protonated amine.

By the contact of the flue gas with the scrubbing solution the gaseous carbon dioxide contained in the flue gas is dissolved in the scrubbing solution or absorbed in the chemical sense. The flue gas which has been freed from carbon dioxide is released into the atmosphere. The scrubbing solution loaded with carbon dioxide can be used elsewhere, where it is regenerated again by a thermal treatment, whereby the carbon dioxide is desorbed. The carbon dioxide deposited can now e.g. be compressed, cooled and liquefied in several stages. In the liquid or supercritical state the carbon dioxide can then be passed to storage or utilization. The regenerated scrubbing solution is employed again for absorbing carbon dioxide from the flue gas.

Undesirably, the nitrogen oxides mentioned are also co-introduced into the absorption process via the flue gas. Depending on the pressure and temperature, nitrogen dioxide and nitrogen monoxide in particular are held in equilibrium here. Nitrogen dioxide radicals can thereby react with water and form nitrites:

2 NO₂+2 OH⁻->2 NO₂⁻+2 OH⁺.

The nitrites formed react adversely with the amines of the absorption agent during the process to form nitrosamines (N-nitroso compounds), which are suspected of being carcinogenic. The nitrosamines formed may have a low vapor pressure, and for this reason they can be discharged together with the purified flue gas into the atmosphere. Nitrosamines are therefore the focus of the current discussions regarding power stations with low emissions with respect to carbon dioxide.

This problem does not arise in gas scrubbing in the chemical industry, since the nitrosating substance (nitrogen dioxide, nitrogen monoxide) as a rule is not present. In some processes, such as e.g. in the tire industry, inhibitors are added to the process in a targeted manner in order to prevent the formation of the N-nitroso components. There are a few known inhibitors in the foodstuffs industry, such as e.g. selenium. The acid medium present there, however, differs significantly from the alkaline conditions when depositing carbon dioxide from a flue gas. In the carbon dioxide deposition process, these inhibitors, if they are active at all under the given conditions, would have to be initially introduced in large amounts in order to compete with the amine present in a high concentration. The high load of inactive substances in the process circulation which must additionally be pumped round has an extremely adverse effect here, as a result of which the efficiency of the power station is reduced further.

### SUMMARY OF INVENTION

An object of the invention is therefore to provide a scrubbing solution of the abovementioned type and a method for depositing carbon dioxide from the flue gas of a combustion system, as a result of which the lowest possible concentration of nitrosamines in the flue gas which has been purified from carbon dioxide can be achieved.

With respect to the scrubbing solution for absorbing carbon dioxide from a flue gas of a combustion system, this object is achieved according to the invention in that, in addition to an amine-containing absorption agent, ozone (O₃) and/or hydrogen peroxide (H₂O₂) are admixed to the scrubbing solution as oxidizing agents for nitrites.

In this context the invention is based on the consideration of promoting a reaction path of nitrites to nitrates, which no longer react further in the process, but form stable salts with metals introduced by the flue gas. This is achieved by the addition of ozone and/or hydrogen peroxide, which are capable of oxidizing nitrites to nitrates in accordance with:

NO₂⁻+H₂O₂->NO₃⁻+H₂O or

NO₂⁻+O₃->NO₃⁻+O₂.

While the oxidation of nitrites to nitrates could alternatively also be forced with catalysts, which remain in the scrubbing solution, ozone and hydrogen peroxide generate completely acceptable water or, respectively, oxygen as the reaction product.

The invention accordingly offers the great advantage that in spite of the decrease in nitrosamines achieved, no further possibly unacceptable substances remain in the scrubbing solution.

By adding ozone and/or hydrogen peroxide to the scrubbing solution, the reaction path of nitrites to nitrates is accordingly promoted without the formation of further possibly undesirable reaction products and without additionally using catalysts, so that the content of nitrosamines in the waste gas of the carbon dioxide deposition is reduced. The oxidation proceeds rapidly and selectively.

However, in an advantageous embodiment of the scrubbing solution—if desired—this oxidation of the nitrites can of course be accelerated by an appropriate catalyst. A carboxylic acid or a manganese oxide, in particular, is suitable as such a catalyst.

In a further advantageous variant, the content of ozone and hydrogen peroxide in total corresponds to the order of magnitude of the nitrites formed, in particular, that is to say, 1-5 mg per standard cubic metre [Nm³] of treated flue gas. An economically relevant reduction in the formation of nitrosamine takes place within the concentration ranges stated.

Advantageously, the scrubbing solution is present as an aqueous solution. The use of water has gained acceptance because of the position of its boiling point and from ecological aspects, and last but not least for reasons of cost.

The amine-containing scrubbing agent can in principle contain an individual amine or a mixture of amines. Amines which can be employed are primary amines, such as monoethanolamine or diglycolamine, secondary amines, such as diethanolamine or diisopropanolamine, and tertiary amines, such as methyldiethanolamines. Complex amines, such as amines which are sterically hindered in carbamate formation or cyclic amines, can likewise be employed. With a sterically hindered amine, carbamate formation is impeded, for example, by a large alkyl group on the amino group, such as is the case, for example, in a 2-amino-2-methyl-1-propanol. A cyclic amine is, for example, a piperazine and its derivatives. An individual amino acid salt, such as, for example, a potassium salt of glycine, or other amino acids can in turn be employed. Mixtures of various amino acid salts can also be employed as absorption agents. The great advantage of the present invention manifests itself in particular in the use of secondary amines, since precisely the nitrosamines formed from secondary amines are stable over time. The primary nitrosamines react further to give alkenes and alcohols, which are significantly more acceptable than the carcinogenic nitrosamines.

With respect to an amino acid salt, it has proved to be advantageous to employ an amino acid salt which has a carbon substituent from the group which contains hydrogen, an alkyl, a hydroxyalkyl and an aminoalkyl. Further, an amino acid salt which has a nitrogen substituent from the group which contains hydrogen, an alkyl, a hydroxyalkyl and a haloalkyl is employed.

In a further embodiment, the amino acid salt is a salt of a metal, in particular an alkali metal.

An object with respect to a method for depositing carbon dioxide from a flue gas of a combustion system is achieved according to the invention in that ozone and/or hydrogen peroxide are admixed as oxidizing agents for nitrites to a scrubbing solution with an amine-containing absorption agent, the flue gas is then brought into contact with the scrubbing solution prepared in this way, whereby carbon dioxide contained in the flue gas is absorbed, and in that the scrubbing solution is then subjected to thermal treatment, whereby the carbon dioxide is desorbed.

Advantageously, the scrubbing solution described above is employed for the method, or such a scrubbing solution is prepared. The advantages mentioned in the dependent claims of the scrubbing solution can be applied here accordingly to the method for depositing carbon dioxide.

Advantageously, the metering in of the oxidizing agents ozone and/or hydrogen peroxide is carried out here continuously according to the order of magnitude of the nitrites formed, in particular, that is to say, to the extent of 1-5 mg per standard cubic metre [Nm³] of treated flue gas. The amount of oxidizing agent in the scrubbing solution thus substantially corresponds to the order of magnitude of the introduction of NO₂ by the flue gas.

### BRIEF DESCRIPTION OF THE DRAWINGS

Embodiments of the invention are explained in more detail with the aid of a drawing. In this:

FIG. 1 shows a diagram of a depositing device for carbon dioxide from the flue gas of a combustion system,

FIG. 2 shows a generally applicable formula for an amino acid salt.

### DETAILED DESCRIPTION OF INVENTION

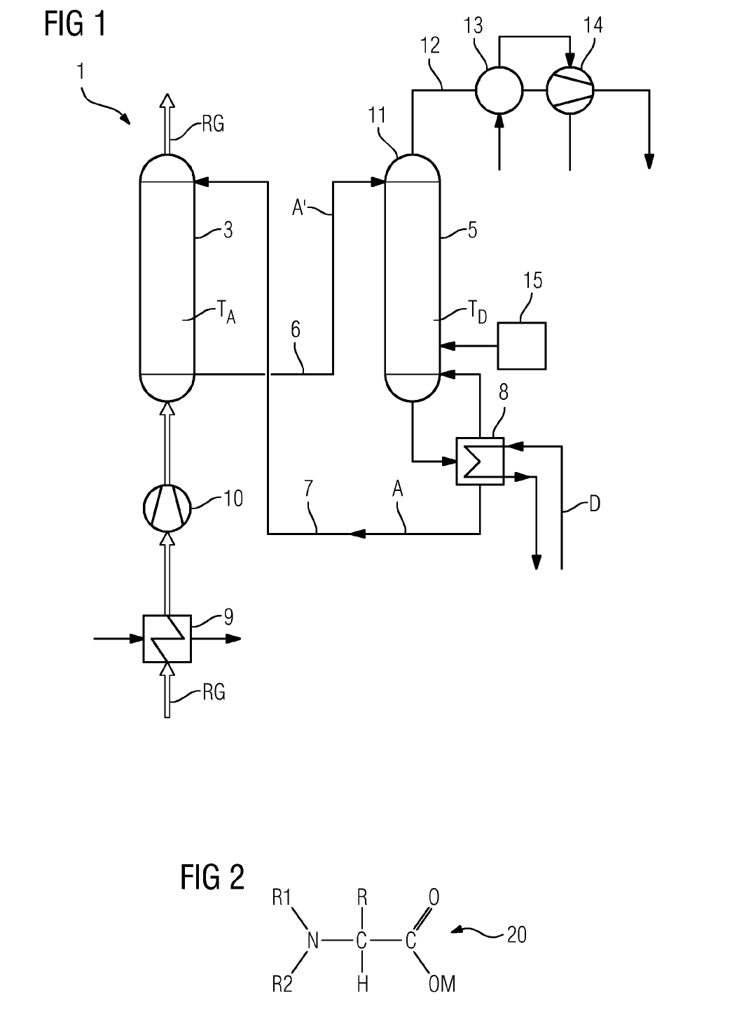

FIG. 1 shows a diagram of a depositing device 1 for depositing carbon dioxide from a flue gas of a combustion system. The depositing device 1 comprises an absorption device 3 and a desorption device 5, between which a loaded scrubbing solution A′ and a regenerated scrubbing solution A circulate in lines 6,7. A scrubbing solution A′ loaded with carbon dioxide is led from the absorption device 3 via line 6 into the desorption device 5 for regeneration. Regenerated scrubbing solution A is brought from the desorption device 5 via line 7 into the absorption device 3 again.

The desorption device 5 is assigned a reboiler 8, through which in the operating case a process steam D of a combustion system is led for supplying heat. This heat is introduced via recirculation of the scrubbing solution A into the desorption device 5, so that scrubbing solution A present therein is heated to a desorption temperature T_{D}, so that dissolved carbon dioxide is subjected to thermal desorption.

For depositing carbon dioxide in the operating case, the flue gas RG of the combustion system is first cooled in a flue gas cooler 9 and then delivered via a conveying device 10 to the absorption device 3. The cool flue gas RG is brought into contact there with regenerated scrubbing solution A in counter-current, so that the carbon dioxide contained in the flue gas is absorbed or dissolved. At an absorption temperature T_{A} the amine-containing scrubbing solution A has a high loading capacity for carbon dioxide. The flue gas RG which has been freed from carbon dioxide is released into the atmosphere.

The scrubbing solution A′ loaded with carbon dioxide flows into the desorption device 5 for regeneration. In the top region of the desorption device 5 gas rich in carbon dioxide is led off via a gas line 12, and is led over a heat exchanger 13 and a subsequent compressor 14. Entrained gaseous carbon dioxide is compressed in the compressor 14 and used for further purposes, for example injected into an aquifer or transported into a carbon dioxide storage system elsewhere.

The depositing device 1 shown is suitable in particular for use in a steam power station, in a gas turbine installation or in a combined gas and steam turbine installation, in particular with integrated gasification of coal, for depositing carbon dioxide from the flue gas. The depositing device 1 is appropriate in particular for modernizing or retrofitting such a power station installation.

The scrubbing solution A employed contains an amine or a mixture of several amines. Advantageously, the scrubbing solution contains an amino acid salt or several amino acid salts. Ozone and/or hydrogen peroxide is/are additionally admixed to the scrubbing solution as oxidizing agents for nitrites. In this context the oxidizing agents are metered in continuously in the same order of magnitude as NO₂ is introduced via the treated flue gas. The reaction path of an oxidation of nitrites to nitrates is promoted in this manner, so that less nitrites are available for the undesirable reaction of nitrites to give nitrosamines. Less nitrosamines are thus formed in the deposition process. The concentration of nitrosamines in the waste gas which has been purified from carbon dioxide decreases. Furthermore, less absorption agent is removed from the deposition process due to the reduced formation of nitrosamines. The demand for absorption agents is thereby reduced, so that the operating costs of the depositing device 1 overall are also thereby lowered.

FIG. 2 shows the general structural formula of an amino acid salt 20 which according to one embodiment is employed as an absorption agent in the scrubbing solution A of the depositing device 1. The scrubbing solution A is added as an aqueous solution in this case.

The amino acid salt 20 has a carbon substituent R and further nitrogen substituents R1 and R2. The carbon substituent R is a compound from the group of hydrogen, alkyl, hydroxyalkyl and aminoalkyl. The further nitrogen substituents R1, R2 are taken from the group of hydrogen, alkyl, hydroxyalkyl and haloalkyl. The amino acid salt 20 is a salt of a metal M, in particular a salt of an alkali metal, for example potassium or sodium, wherein a proton in the carboxyl group is replaced by the metal M in the ionic form.

After the carbon dioxide has been deposited by means of the scrubbing solution described above, on addition of ozone and/or hydrogen peroxide, the scrubbing solution employed in the process contains alkali metal oxides of higher nitrate values. The oxidation of nitrites to nitrates is thus promoted. Less nitrosamines form.

1.-12. (canceled)

13. A scrubbing solution for absorbing carbon dioxide from a flue gas of a combustion system, comprising:
at least one amine-containing absorption agent, and ozone and/or hydrogen peroxide, for the oxidation of nitrites to nitrates.

14. The scrubbing solution according to claim 13, further comprising a catalyst for the oxidation of the nitrites.

15. The scrubbing solution according to claim 13, wherein the scrubbing solution comprises an aqueous solution.

16. The scrubbing solution according to claim 13, further comprising a plurality of amines.

17. The scrubbing solution according to claim 13, further comprising
an alkanolamine and/or an amine which is sterically hindered in carbamate formation is as an amine.

18. The scrubbing solution according to claim 13, further comprising an amino acid salt as an amine.

19. The scrubbing solution according to claim 18,
wherein the amino acid salt has a carbon substituent selected from the group comprising hydrogen, an alkyl, a hydroxyalkyl and an aminoalkyl.

20. The scrubbing solution according to claim 18,
wherein the amino acid salt has a nitrogen substituent selected from the group comprising hydrogen, an alkyl, a hydroxyalkyl and a haloalkyl.

21. The scrubbing solution according to claim 18,
wherein the amino acid salt is a salt of a metal.

22. A method for depositing carbon dioxide from a flue gas of a combustion system, comprising:
admixing ozone and/or hydrogen peroxide as an oxidizing agent for nitrites to a scrubbing solution with an amine-containing absorption agent,
bringing into contact the flue gas with the scrubbing solution, wherein carbon dioxide contained in the flue gas is absorbed, and wherein the ozone and/or the hydrogen peroxide oxidizes the nitrites to nitrates, and
subjecting the scrubbing solution to thermal treatment, whereby the carbon dioxide is desorbed.

23. The method according to claim 22,
wherein a scrubbing solution for absorbing carbon dioxide from a flue gas of a combustion system, comprising at least one amine-containing absorption agent, and ozone and/or hydrogen peroxide, for the oxidation of nitrites to nitrates is prepared.

24. The method according to claim 22,
wherein the metering in of the oxidizing agents ozone and/or hydrogen peroxide is carried out continuously according to an order of magnitude of the nitrites formed.

25. The method according to claim 22,
wherein the metering in of the oxidizing agents ozone and/or hydrogen peroxide is carried out continuously according to an order of magnitude of the nitrites formed, to the extent of 1-5 mg per standard cubic metre [Nm3] of treated flue gas.

26. The scrubbing solution according to claim 14,
wherein the catalyst for the oxidation of the nitrites comprises a carboxylic acid or a manganese oxide.

27. The scrubbing solution according to claim 18,
wherein the amino acid salt is a salt of an alkali metal. 3
